(19) United States
(12) Patent Application Publication
(10) Pub. No.: US 2013/0066565 A1
(43) Pub. Date: Mar. 14, 2013

(54) SYSTEMS AND METHODS OF CONFIGURING GAS DETECTION EQUIPMENT BASED ON A USER INTERVIEW

(71) Applicants: Emily Gail Fabes, Calgary (CA); Sean Stinson, Calgary (CA); Clive Warden Kennard, Calgary (CA); Shane Lee McEwen, Calgary (CA)

(72) Inventors: Emily Gail Fabes, Calgary (CA); Sean Stinson, Calgary (CA); Clive Warden Kennard, Calgary (CA); Shane Lee McEwen, Calgary (CA)

(73) Assignee: Honeywell International Inc., Morristown, NJ (US)

(21) Appl. No.: 13/232,155

(22) Filed: Sep. 14, 2011

(51) Int. Cl. G06F 19/00

(52) U.S. Cl. 702/24

(57) ABSTRACT

Systems and methods of configuring gas detection equipment based on a user interview are provided. Methods include presenting a plurality of questions to a user regarding the gas detection equipment, receiving user feedback responsive to each of the plurality of questions, and determining configuration parameters, in accordance with the user feedback, for bringing piece the gas detection equipment into a compliant state.

### FIELD

The present invention relates generally to systems and methods of determining configuration parameters and/or configuring gas detection equipment based on a user interview to bring the gas detection equipment into a compliant state. More particularly, the present invention relates to systems and methods for presenting questions to a user, receiving user input, and determining configuration parameters and/or configuring gas detection equipment based on the user input.

### BACKGROUND

In many life safety systems, gas detection equipment is ubiquitous. For example, many life safety systems employ gas detectors, gas detector docking stations, and the like.

Gas detection equipment can be configured in a plurality of different manners to suit a user's specific application. Many pieces of gas detection equipment provide users with configuration options to perform the device configuration. For example, some configuration options allow a user to configure gas detection equipment to comply with governmental regulations, with company policies on gas detection usage, and the like.

To configure gas detection equipment, users are often presented with a list of options, from which they can select options to configure. However, because there are so many options to configure in gas detection equipment, users can be presented with a list of more than seventy-five options to configure. Such lists and options can be overwhelming to a user, especially to a user without the technical expertise to know what options need configuration. Furthermore, properly configuring gas detection equipment to be compliant with governmental regulations or company policies can be complex because users often do not know which options they must select to meet their needs.

There is thus a continuing, ongoing need for systems and methods of determining configuration parameters and/or configuring gas detection equipment based on a user interview to change a state of a device from a non-compliant to compliant state. Preferably, such systems and methods can present questions to a user, receive user input, and determine configuration parameters and/or configure gas detection equipment based on the user input.

### BRIEF DESCRIPTION OF THE DRAWINGS

FIG. 1 is a flow diagram of one embodiment of a method of determining configuration parameters and configuring gas detection equipment in accordance with the present invention;

FIG. 2 is a flow diagram of one embodiment of a method of presenting a set of interview questions to a user in accordance with the present invention;

FIG. 3 is a flow diagram of one embodiment of a method of presenting a set of interview questions to a user in accordance with the present invention;

FIG. 4 is a flow diagram of one embodiment of a method of determining configuration parameters and creating a configuration profile in accordance with the present invention;

FIG. 5 is a flow diagram of one embodiment of a method of determining configuration parameters and configuring gas detection equipment in accordance with the present invention;

FIG. 6 is a block diagram of a system for carrying out the methods of FIGS. 1-5 and others in accordance with the present invention; and

FIG. 7 is an interactive window displayed on a viewing screen of a graphical user interface for determining configuration parameters and configuring gas detection equipment in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods of configuring gas detection equipment based on a user interview to change a state of a device from non-compliant to compliant state. Embodiments of the present invention also include systems and methods of conducting a user interview to determine configuration parameters to bring a device from a non-compliant to compliant state and, in some embodiments, delivering the determined configuration parameters to at least one of a gas detection device, a docking station, and a user interface.

Preferably, such systems and methods in accordance with the present invention can present questions to a user, receive user input, and determine configuration parameters for gas detection equipment based on the user input. Thus, systems and methods of the present invention can act as an expert consultant to a user. That is, systems and methods in accordance with the present invention can aid a user in configuring his gas detection equipment.

It is to be understood that systems and methods of the present invention can determine configuration parameters for a device to change the state of the device from a non-compliant state to a compliant state. For example, what constitutes a compliant state of a device can depend on environmental factors or governmental and company policies. Systems and methods of the present invention can obtain feedback from a user to determine what parameters need to be changed to bring the device into a compliant state.

In accordance with the present invention, an executable software program can run on hardware of a computer, for example, a personal computer. In some embodiments, the computer hardware can be associated with a docking station receiving gas detection equipment.

While the software program is running, a user can be presented with a series of questions. For example, the questions can be about the user's work environment, location, gas detection equipment, and the like. The questions can solicit user input even from a user that has little or no knowledge about gas detection terminology.

A user can provide feedback by entering answers to the presented questions, and, based upon the user input, systems and methods in accordance with the present invention can determine an appropriate configuration for the user's gas detection equipment to bring the equipment into a compliant state. Once the appropriate configuration is determined, systems and methods can then transmit those configuration parameters or actually configure the gas detection equipment in accordance with the determined configuration.

In embodiments of the present invention, a set of questions to be presented to a user can be developed to effectively and efficiently aid users with little or no experience with gas detection equipment to properly configure their equipment so as to be compliant with all applicable requirements. For example, when systems and methods of the present invention are initiated, an initial question can be presented to a user. The initial question can be, for example, “Would you like to fully automate the compliance of your gas detector?” Presenting a question to a user can include displaying that question to the user on a user interface, for example.

When a question is presented to a user, the user can have three options for responding: yes, no, or more information. Depending on which icon or button the user selects, systems and methods can proceed accordingly.

When a user selects an icon or button indicating that he would like more information, information about what will occur if the user selects yes or no to the presented question can be displayed. For example, when a user selects more information responsive to the initial question “Would you like to fully automate the compliance of your gas detector?”, the following exemplary message can be displayed: “Selecting this option will automatically detect a device on insertion and interrogate the detector status. Calibration and bump check operations will be performed as required and a full functional test of the detector will be completed. The status of the detector will be displayed on completion. The detector will either be compliant or disabled. If disabled, you will be advised to have the detector serviced. An optional custom message or instruction can also be displayed, and you will be given the option to set this message later.”

When a user selects an icon or button answering yes to the initial message, a specific combination of settings can be activated that result in automatically detecting an inserted device, interrogating the device regarding its functional status, and then performing any required operations to bring the device into a compliant state. After the user enters his input to answer yes to the initial question, the user interaction with systems and methods of the present invention can be minimal. For example, the user need only insert his gas detection device and remove the device upon completion of any configuration.

After performing required operations on a gas detection device, systems and methods of the present invention can provide feedback to the user regarding the new status of the device. For example, systems and methods can provide feedback indicating if the device is compliant or disabled. In embodiments of the present invention, the feedback to the user can clearly display the status of the user, and if the status is disabled, systems and methods can also display an additional informational message to the user. For example, the additional informational message could include: “Please go to a service center and exchange this detector.”

When, however, a user selects an icon or button answering no to the initial message, systems and methods in accordance with the present invention can present a set of questions to the user. For example, the set of questions can include: “Would you like the detector status interrogation to be automatically started or would you like to initiate the detector status interrogation process with a button press?”

When the full set of questions has been answered by the user, set up can be complete, and systems and methods in accordance with the present invention can configure the device in accordance with the user's answers to the questions. In some embodiments, a user can have an opportunity to revert to a previous question and/or escape the configuration process entirely.

Systems and methods in accordance with the present invention can monitor user input for conflicting answers. For example, if the user answers two or more questions with answers that conflict, systems and methods can notify the user of the conflict and solicit clarification.

In some embodiments, the set of questions presented to the user can be adaptive. For example, systems and methods can determine and alter questions presented to the user based on the user's answers to previous questions. In some embodiments, when a user's answer selects a specific function, other functions that would conflict with the selected specific function can be unavailable to the user. That is, in some embodiments, the user is not presented with functions that would conflict with a previously selected specific function.

It is to be understood that the questions and feedback described herein are exemplary only. The questions and feedback that can be provided to a user are not so limited. Rather, the questions and feedback that can be provided to a user can be any as would be desired by one of skill in the art.

According to embodiments of the present invention, a user can also have the option of selecting functions manually to bring a device into a compliant state. When a function is selected manually, systems and methods of the present invention can provide feedback to the user. For example, the feedback could describe to the user the behavior of the gas detection equipment that will result from the user's selection. The feedback could also describe to the user adaptive functions that will result from the user's selection. For example, the feedback could describe to the user what other function's will be made unavailable because of the user's selection.

Systems and methods according to the present invention can include a plurality of predetermined configuration profiles for predetermined compliant states. For example, each of the predetermined configuration profiles can accommodate a frequently used setting combination of a gas detection device for a predetermined application.

One exemplary predetermined configuration profile can be for a gas detection device in a large facility operating twenty-four hours on a shift system where a fully automated quick turnaround bump and calibration is required. Another exemplary predetermined configuration profile can be for a gas detection device used by a first responder so the device must be fully charged and ready for twenty-four hours. Other predetermined configuration profiles come within the spirit and scope of the present invention.

Manually configuring a gas detection device in accordance with any of the predetermined configuration profiles can be a time intensive process. However, when the configuration profiles are predetermined, time can be saved. For example, a user need only insert a gas detection device into a docking station and select the appropriate predetermined configuration profile. Then, systems and methods in accordance with the present invention can automatically configure the device in accordance with the selected options of the predetermined configuration profile to bring the device into a compliant state.

In embodiments of the present invention, a user can set up a predetermined configuration profile by manually configuring a first gas detection device with a set of options. The set of options can be saved and associated with the predetermined configuration profile. Then, when a second gas detection device is to be configured to bring the second gas detection device into a compliant state, the user can select the previously set up predetermined configuration profile to configure the second gas detection device.

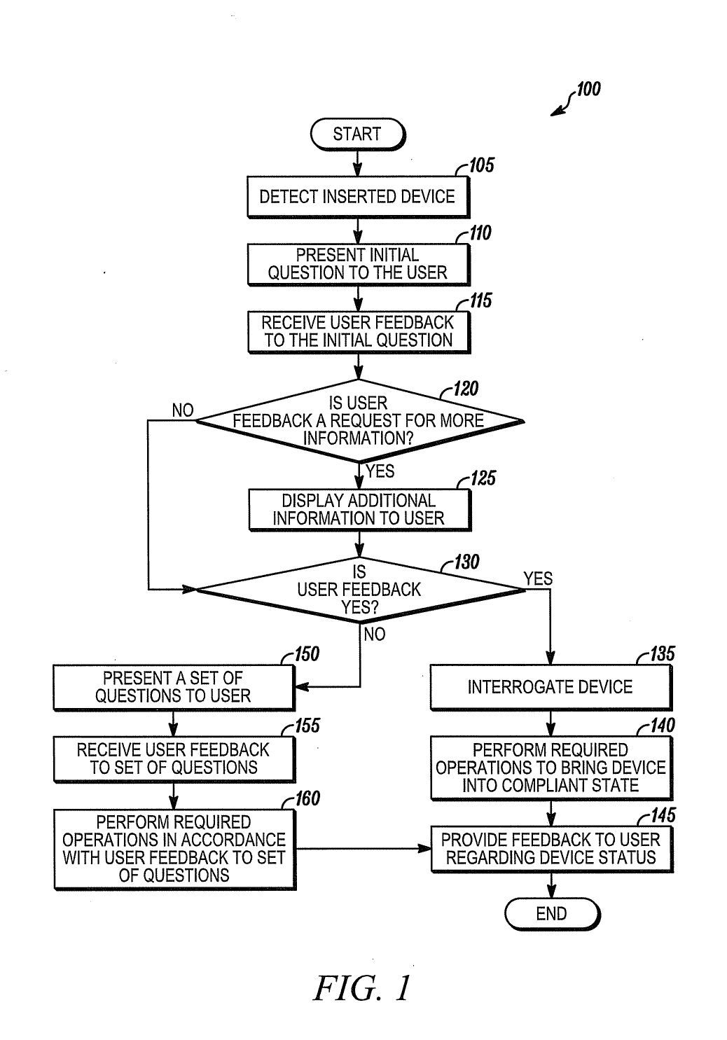

FIG. 1 is a flow diagram of one embodiment of a method 100 of determining configuration parameters and configuring gas detection equipment in accordance with the present invention. As seen in FIG. 1, an inserted gas detection device can be detected as in 105. Then, an initial question can be presented to a user as in 110, and user feedback to the initial question can be received as in 115.

For example, in some embodiments, the initial question can be presented to the user by visually, with text and/or graphics, displaying the initial question on a viewing screen of a user interface. In some embodiments, the initial question can be audibly presented to the user via a speaker.

The user feedback can be received via an input mechanism, for example, a user input such as a button or icon on a touch-sensitive screen, selected by the user. In some embodiments, the user feedback can be received via a microphone into which the user speaks his feedback.

The method 100 can determine if the user feedback to the initial question is a request for more information as in 120. If yes, then the method 100 can display the additional information to the user as in 125. However, if the user feedback to the initial question is not a request for more information as in 120, then the method 100 can determine if the user feedback to the initial question is an affirmative answer as in 130.

If the user feedback to the initial question is an affirmative answer as in 130, then the method 100 can interrogate the device as in 135 and perform any required operations to bring the device into a compliant state as in 140. Then, feedback regarding the status of the device can be presented to the user as in 145.

However, if the user feedback to the initial question is not an affirmative answer as in 130, then the method 100 can present a set of questions to the user as in 150 and receive user feedback to the set of questions as in 155. Based on the user feedback to the set of questions, the method 100 can perform any required operations as in 160 and then provide feedback to the user regarding the status of the device as in 145.

In some embodiments, the method 100 can present to the user all of the questions in the set of questions, receive the user feedback to all of the questions in the set of questions, and then perform the required operations in accordance with the user feedback to all of the questions in the set of questions. That is, the required operations can be performed after all of the user feedback has been received.

However, in other embodiments, the method 100 can present to the user one question in the set of questions, receive the user feedback to the one question in the set of questions, and then perform the required operations in accordance with the user feedback to the one question. Then, the next question can be presented, and the process can repeat as many times as necessary. Thus, in this embodiment, a required operation can be performed as necessary after user feedback is received to each presented question.

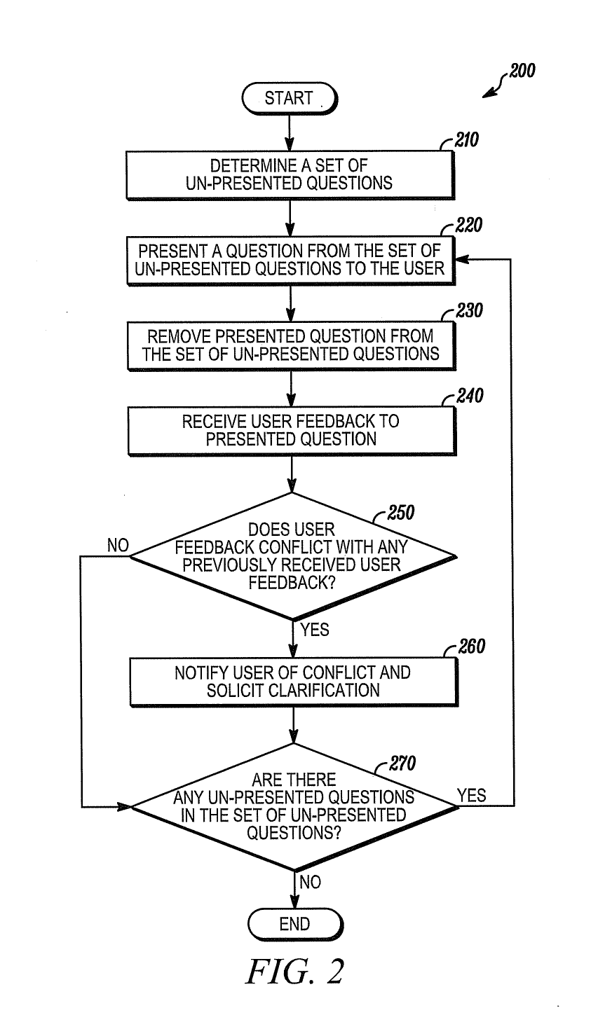

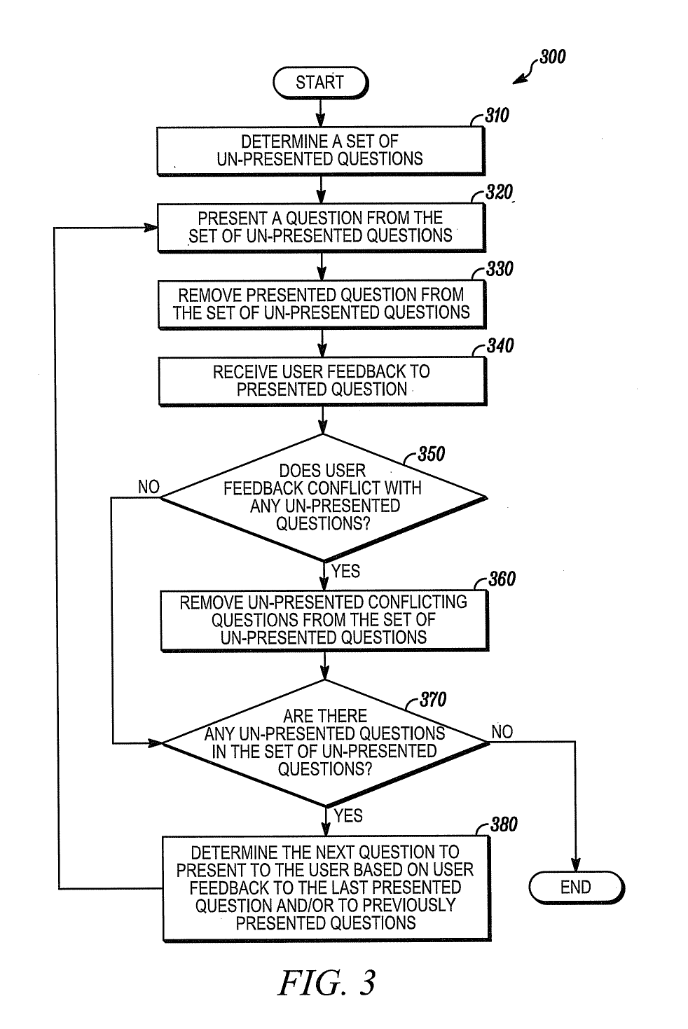

Presenting a set of questions to the user as in 150 and receiving user feedback to the set of questions as in 155 can include one or both of the methods 200, 300 show in FIG. 2 and FIG. 3, respectively.

As seen in FIG. 2, the method 200 can start by determining a set of un-presented questions as in 210. For example, this could include retrieving the set of questions from an associated memory or database. Then, the method 200 can present a question to a user from the set of un-presented questions as in 220. The question presented in 220 can be removed from the set of un-presented questions as in 230, and the method 200 can receive user feedback to the presented question as in 240.

The method 200 can determine if the user feedback to the presented question conflicts with any previously received user feedback as in 230. If yes, then the method 200 can notify the user of the conflict and solicit clarification as 260.

Then, the method 200 can determine if there are any un-presented questions left in the set of un-presented questions as in 270. If yes, then the method 200 can again present a question to the user from the set of un-presented questions as in 220. However, if there are no un-presented questions left in the set of un-presented questions as in 270, then the method can terminate.

If the method 200 determines that the user feedback to the presented question does not conflict with any previously received user feedback as in 230, then the method 200 can proceed to determine if there are any un-presented questions left in the set of un-presented questions as in 270.

As seen in FIG. 3, the method 300 can start by determining a set of un-presented questions as in 310. For example, this could include retrieving the set of questions from an associated memory or database. Then, a question from the set of un-presented questions can be presented to the user as in 320. The question presented in 320 can be removed from the set of un-presented questions as in 330, and user feedback to the presented question can be received as in 340.

The method 300 can determine if the user feedback to the presented question conflicts with any un-presented questions still in the set of un-presented questions as in 350. If yes, then the method 300 can remove the un-presented conflicting questions from the set of un-presented questions as in 360. Then, the method can determine if there are any un-presented questions still in the set of un-presented questions as in 370.

If the method 300 determines that the user feedback to the presented question does not conflict with any un-presented questions still in the set of un-presented questions as in 350, then the method can proceed to determining if there are any un-presented questions still in the set of un-presented questions as in 370.

If there are no un-presented questions left in the set of un-presented questions as in 370, then the method 300 can terminate.

However, if the method 300 determines that there are un-presented questions left in the set of un-presented questions as in 370, then the method can determine the next question from the set of un-presented questions to present to the user as in 380. The next question to present can be based on user feedback to previously presented questions. Then the method 300 can present the determined next question to the user as in 320.

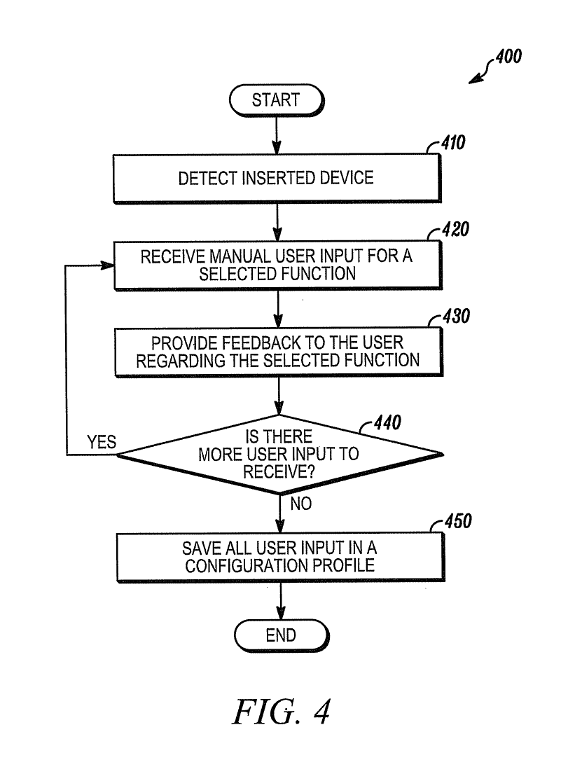

FIG. 4 is a flow diagram of one embodiment of a method 400 of determining configuration parameters and creating a configuration profile in accordance with the present invention. As seen in FIG. 4, a gas detection device can be inserted as in 410. Then, the method can receive manual user input for a selected function as in 420. The method 400 can provide feedback to the user regarding the selected function as in 430 and then determine if there is more user input as in 440.

If there is more user input as in 440, then the method 400 can continue to receive manual user input as in 420. However, if there is no more user input as in 440, then the method 400 can save all received manual user input in a configuration profile 500. Thus, the configuration profile can configure all options that correspond to the received manual user input.

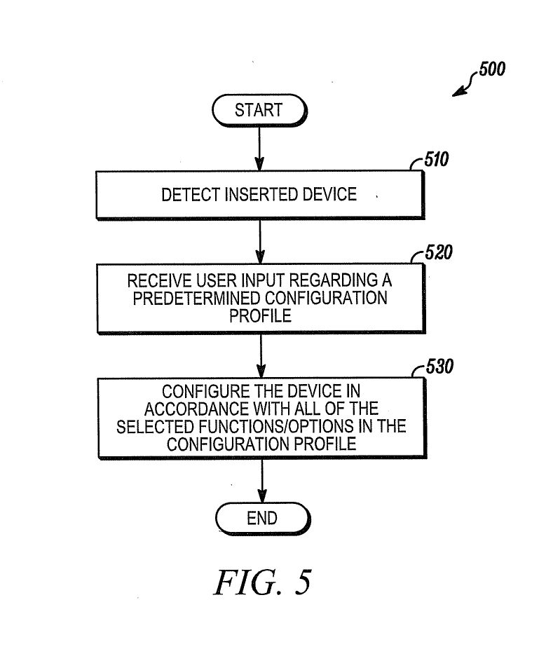

FIG. 5 is a flow diagram of one embodiment of a method 500 of determining configuration parameters and configuring gas detection equipment in accordance with the present invention. In some embodiments of the present invention, the method 500 shown in FIG. 5 can be performed after completion of the method 400 shown in FIG. 4.

As seen in FIG. 5, an inserted gas detection device can be detected as in 510. Then, the method 500 can receive user input regarding a predetermined configuration profile as in 520. For example, the predetermined configuration profile can be one that was created as in 450 in the method 400.

Finally, the method 500 can configure the device in accordance with the predetermined configuration profile as in 530. For example, the predetermined configuration profile can have a set of selected options associated therewith. The method 500 can perform operations to the device in accordance with the selected options.

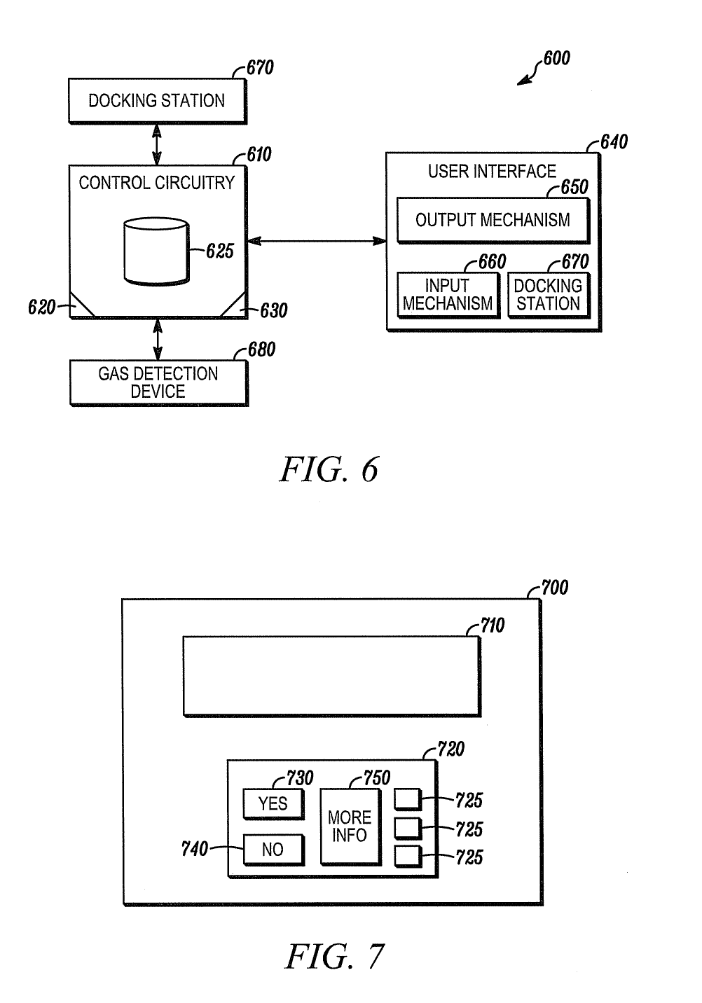

The methods shown in FIGS. 1-5 and others in accordance with the present invention can be implemented with the system 600 shown in FIG. 6. As seen in FIG. 6, the system 600 can include control circuitry 610, a database 625, one or more programmable processors 620, and executable control software 630 as would be understood by those of skill in the art. The executable control software 630 can be stored on a transitory or non-transitory local computer readable medium.

In some embodiments, the database 625 can include a memory or storage. For example, the database 625 can store in its memory a plurality of questions to be presented to a user and feedback received from the user.

In some embodiments, the control circuitry 610 and programmable processor 620 can execute the software 630 to conduct a user interview and determine and deliver configuration parameters to a detector for bringing the detector into a compliant state. It is to be understood that in embodiments of the present invention, the software 630 does not bring a gas detection device into a compliant state. Rather, the software 630 stored on a transitory or non-transitory local computer readable medium determines configuration parameters, based on user feedback to presented question, to bring the device into the compliant state.

In some embodiments, the control circuitry 610, with the programmable processor 620 and software 630 can deliver the determined configuration parameters to a device 680 via a direct connection to the device 680, via a direct connection to a docking station 670, or via a user interface 640 associated with the control circuitry 610.

In embodiments in which the control circuitry 610 communicates directly with a gas detection device 680, the control circuitry 610 can be embodied in a computer, for example, a personal computer, and can communication with the device 680 via, for example, a USB or infrared connection. In these embodiments, the control circuitry 610 can perform the methods of FIGS. 1-5 and others in accordance with the present invention without first detecting an inserted device. That is, the control circuitry 610 and the programmable processor 620 can execute the software 630 to conduct a user interview and determine configuration parameters for bringing a device into a compliant state. Then, the control circuitry 610 can directly connect with the device 680 for transmitting the determined configuration parameters to the device 680.

In embodiments in which the control circuitry 610 communicates directly with a docking station 670, the docking station 670 can include a user interface with input and output mechanisms as described herein.

In embodiments in which an associated user interface 640 is in communication with the control circuitry 610, the interface 640 can include one or more output mechanisms 650, input mechanisms 660, and docking stations 670. In some embodiments of the present invention, the user interface 640 can be a multi-dimensional graphical user interface.

In embodiments of the present invention, the output mechanism 650 can present interview questions and feedback to a user. For example, the output mechanism 650 can include a viewing screen, as would be known by those of skill in the art, that can display interactive and viewing windows. The output mechanism 650 can also include a speaker for audibly emitting questions and/or feedback to a user.

The input mechanism 660 can receive user feedback to presented questions as well as receive manual input and input regard a predetermined configuration profile. For example, the input mechanism 660 can include a plurality of buttons or icons on a touch-sensitive screen for users to select. The input mechanism can also include a microphone into which a user can speak his answers to presented questions.

Finally, the docking station 670 station can receive and interface with a gas detection device inserted therein. For example, the system 600 can interrogate a device in the docking station 670, perform required operations on a device in the docking station 670, and configure a device in the docking station 670 to bring the device from a non-compliant state to a compliant state. Thus, in embodiments of the present invention, the docking station 670 can act as a conduit for transmitting configuration parameters from the control circuitry 610, programmable processor 620, and software 630 to a gas detection device inserted in the docking station 670.

FIG. 7 is an interactive window 700 that can be displayed on a viewing screen of a graphical user interface for determining configuration parameters and configuring gas detection equipment in accordance with the present invention. The window 700 shown and described herein is exemplary only. Those of skill in the art will understand that the features of the window 700 can be displayed by additional or alternate windows.

As seen in FIG. 7, the window 700 can include an output presenting sub-window 710 and an input receiving sub-window 720.

The output presenting sub-window 710 can present a plurality of different information to a user. For example, the output presenting sub-window 710 can present questions to a user, present feedback to the user, present additional information to a user, and/or notify the user about any conflicts. In embodiments of the present invention, information presented to the user via the output presenting sub-window 710 can be presented with text and/or graphics on the sub-window 710.

The input receiving sub-window 720 can receive a plurality of different information from a user. For example, the input receiving sub-window 720 can receive user feedback to presented questions, receive clarification about a user's selection, or receive any other user input, for example, manual selections or a selection of a predetermine configuration profile. In embodiments of the present invention, the input receiving sub-window 720 can include a plurality of different user input mechanisms 725, for example, buttons or icons, corresponding to letters or numerals or any other predetermine buttons or icons as would be desired.

For example, the input receiving sub-window 720 can include input mechanisms 730, 740, 750 corresponding to the user feedback of “Yes,” “No,” and “More Information,” respectively.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method comprising:
presenting a plurality of questions to a user regarding a piece of gas detection equipment;
receiving user feedback responsive to each of the plurality of questions; and
determining configuration parameters, in accordance with the user feedback, for bringing piece the gas detection equipment into a compliant state.

2. The method of claim 1 wherein presenting the plurality of questions to the user includes presenting an initial question to the user.

3. The method of claim 2 wherein, when the user feedback includes a request for more information, displaying information to the user regarding consequences of answering the initial question.

4. The method of claim 2 wherein, when the user feedback includes an affirmative answer to the initial question, automatically interrogating the piece of gas detection equipment to determine the configuration parameters.

5. The method of claim 1 further comprising displaying a status indicator of the piece of gas detection equipment.

6. The method of claim 1 wherein presenting the plurality of questions and receiving the user feedback includes:
determining a plurality of un-presented questions;
presenting a first question to the user from the plurality of un-presented questions;
removing the first question from the plurality of un-presented questions;
receiving user feedback to the first question;
determining if the user feedback to the first question conflicts with any previously received user feedback;
determining if any questions remain in the plurality of un-presented questions; and
when questions remain in the plurality of un-presented questions, presenting each of the remaining questions to the user.

7. The method of claim 7 further comprising, when the user feedback to the first question conflicts with the previously received user feedback, notifying the user of the conflict, and soliciting clarification from the user.

8. The method of claim 1 wherein presenting the plurality of questions and receiver the user feedback includes:
determining a plurality of un-presented questions;
presenting a first question to the user from the plurality of un-presented questions;
removing the first question from the plurality of un-presented questions;
receiving user feedback to the first question;
determining if the user feedback to the first question conflicts with any questions in the plurality of un-presented questions; and
determining if any questions remain in the plurality of un-presented questions.

9. The method of claim 8 wherein, when the user feedback to the first question conflicts with questions in the plurality of un-presented questions, removing the conflicting questions from the plurality of un-presented questions.

10. The method of claim 8 wherein, when questions remain in the plurality of un-presented questions, determining a next question to present based on the user feedback to the first question, and presenting the next question to the user.

11. The method of claim 1 further comprising detecting the piece of gas detection equipment.

12. The method of claim 1 further comprising communicating the determined configuration parameters to at least one of the piece of gas detection equipment and a docking station for receiving the piece of gas detection equipment.

13. A method comprising:
receiving manual user input from a user for selecting a function of a first piece gas detection equipment;
determining a first configuration parameter, in accordance with the manual user input, for bringing the first piece of gas detection equipment into a compliant state; and
creating a configuration profile with the selected function.

14. The method of claim 13 further comprising receiving user input from the user for selecting a plurality of functions of the first piece of gas detection equipment.

15. The method of claim 13 further comprising displaying consequences of selecting the function.

16. The method of claim 13 further comprising:
receiving user input for selecting the configuration profile; and
determining the first configuration parameter for bringing the second piece of gas detection equipment into a compliant state.

17. A system comprising:
executable control software stored on a non-transitory computer readable medium; and
at least one programmable processor for:
presenting a plurality of questions to a user regarding a piece of gas detection equipment;
receiving user feedback responsive to each of the plurality of questions; and
determining configuration parameters, in accordance with the user feedback, for bringing piece the gas detection equipment into a compliant state.

18. The system of claim 17 further comprising a database for storing the plurality of questions and for storing the user feedback.

19. The system of claim 17 further comprising a transceiver for communicating the determined configuration parameters to at least one of the piece of gas detection equipment, a docking station, and a user interface.

20. The system of claim 19 wherein at least one of the docking station and the user interface includes at least one of an input mechanism and an output mechanism.
